(19) United States
(12) Patent Application Publication
(10) Pub. No.: US 2019/0293547 A1
(43) Pub. Date: Sep. 26, 2019

(54) SENSOR SYSTEM FOR PIPELINE INTEGRITY MONITORING

(71) Applicant: The Governors of the University of Alberta, Edmonton (CA)

(72) Inventors: MOJGAN DANESHMAND, EDMONTON (CA); SAMEIR DEIF, EDMONTON (CA); MOHAMMAD HOSSEIN ZARIFI, EDMONTON (CA); NAHID VAHABISANI, EDMONTON (CA)

(21) Appl. No.: 16/364,632

(22) Filed: Mar. 26, 2019

Related U.S. Application Data
(60) Provisional application No. 62/647,891, filed on Mar. 26, 2018.

(51) Int. Cl. G01N 17/04

(52) U.S. Cl. CPC G01N 17/04

(57) ABSTRACT

A system and method for monitoring condition of a vessel coating layer and detecting compromise of the coating and its causes are provided. The system includes a sensor positioned on a coating layer of the vessel, and a reader for reading a resonant behavior of the sensor. The method includes positioning an array of a plurality of sensors on the coating layer, reading a resonant frequency of each sensor using the reader, and monitoring the resonant frequency of the sensors for a variation in the resonant frequency of at least one sensor, the variation in the resonant frequency of the at least one sensor indicating a change in the condition of the coating layer. Variations in the resonant frequency being indicative of breaches such as water penetration, air penetration, corrosion, stress, strain, and cracking. Thus, proactive prediction of a cause and location of coating breaches is accomplished.

### CROSS-REFERENCE TO RELATED APPLICATIONS

This application claims priority of U.S. Provisional Patent Application Ser. No. 62/647,891 filed Mar. 26, 2018, which is incorporated herein by reference.

### FIELD OF THE INVENTION

This disclosure generally relates to methods and systems for monitoring pipelines using a Microwave sensor array, and more particularly to a method for detecting a coating defect in a pipeline using resonant-based Microwave sensors embedded in the pipe structure.

### BACKGROUND OF THE INVENTION

Pipelines in Canada play a critical role in oil-sand industry since over 73,000 kilometers of pipelines move approximately 1.3 billion barrels of oil per year. Additionally, there are an estimated 840,000 kilometers of transmission, gathering, and distribution lines including 117,000 kilometers of large diameter transmission lines. For oil and natural gas pipelines, corrosion (internal and external) is the leading cause of pipeline failure (65% and 34%, respectively). Therefore, real-time monitoring of pipelines and early detection of pipeline corrosion are crucial for environment protection and society safety. Pipelines are mostly protected with two main methods: anti-corrosive coatings, and Cathodic Protection (CP) systems. High-performance coatings applied to the pipe's metal surface, in conjunction with effective CP can effectively delay external corrosion. This happens by insulating the electrolyte (soil, water, etc.) from reaching the metal surface. Therefore, the adhesion between the coating and the surface of the pipeline is an important parameter to monitor. When the coating fails, the humidity and/or salty-water can penetrate beneath the coating and lead to corrosion of metal at an exposed area. Such problems are exhibited in pipelines around the world, including energy pipelines and water pipelines.

While there have been many advances in sensor technologies, there continues to be a need for low-cost, battery-free, and wireless sensors for pipeline monitoring and breach detection of coating layers. There also exists a need to be able to interrogate the output from such sensors as a function of time to afford for preventative maintenance of pipeline compromise.

### SUMMARY OF THE INVENTION

A system for detecting compromise of a coating on a vessel and its causes is provided. The system includes a resonant passive radiofrequency and microwave design-based sensor positioned on a coating layer of the vessel, and a reader for reading a resonant behavior of the sensor. According to embodiments of the system, reading and monitoring the resonant behavior of the sensor allows for proactive prediction of a cause of coating breaches. A decrease in the resonant frequency of the sensor is indicative of a water penetration breach of the coating layer, while an increase in the resonant frequency of the sensor is indicative of an air penetration breach of the coating layer.

A method for monitoring a condition of a coating layer of a vessel is provided. The method includes positioning an array of a plurality of resonant passive radiofrequency and microwave design-based sensors on the coating layer of the vessel, reading a resonant frequency of each sensor of the plurality sensors using a reader, and monitoring the resonant frequency of the plurality of sensors for a variation in the resonant frequency of at least one sensor, the variation in the resonant frequency of the at least one sensor indicating a change in the condition of the coating layer.

### BRIEF DESCRIPTION OF THE DRAWINGS

The present invention is further detailed with respect to the following drawings that are intended to show certain aspects of the present of invention, but should not be construed as limit on the practice of the invention, wherein:

FIG. 1 is a perspective view of the system of the present invention with sensor patched (stamped) on a pipeline, which is interrogated and read using coil (s) (or antenna(s));

FIG. 2A is a perspective view of an embodiment of the system of the present invention;

FIG. 2B is a side view of the system of FIG. 2A with a coating and a metal pipe of the system shown;

FIG. 2C is a lumped circuit model of the sensor and reader of the system of the present invention;

FIG. 2D is a top view showing design parameters off an interdigitated capacitor of the system of the present invention;

FIG. 3A is a graph showing simulation results for a variant breaching height plotted with S11-parameters versus frequency for different breaching heights with air filled volume;

FIG. 3B is a graph showing simulation results for a resonant frequency comparison for air and water filled gap volume for variant breaching heights;

FIG. 4A is a perspective view of an interdigitated capacitor of the system of the present invention;

FIG. 4B shows lumped elements representation for the interdigitated capacitor of FIG. 4A;

FIG. 5A is a graph showing resonant profiles of the reader coil for variant air flow rate in SCCM (volume change) in the gap volume between the coating and pipe;

FIG. 5B is a graph showing resonant profiles for variant water height (mm) in the gap volume between the coating and pipe;

FIG. 6A is a graph showing resonant frequency in five independent examples of coating lift-off with different air flow rates;

FIG. 6B is a graph showing resonant frequency in five independent examples of water ingress height between the coating and pipe (volume was translated to gap variation);

FIG. 7 is a perspective view of the system according to embodiments of the present invention with a sensor patched (stamped) on a pipeline, which is interrogated and read using a RFID held by a drone scanner;

FIG. 8A shows a spiral resonator;

FIG. 8B shows an equivalent circuit for the spiral resonator of FIG. 8A;

FIG. 8C shoes the equivalent circuit for the spiral resonator of FIG. 8A at resonance state;

FIG. 9 is the sensor array design showing a gradual length increase/decrease corresponding to a frequency decrease/increase;

FIG. 10 is the transmission coefficient (S21) in magnitude (in dB) and phase (in Deg.) for 7 spirals array;

FIG. 11 is the Electric field distribution (in Mag. [V/m]) at each resonance frequency for the elements of the sensor array;

FIG. 12A is a schematic diagram showing a cross section of a pipeline with sensors arranged on the pipeline coating layer with polymer tubes to insert water below sensors and within the coating layer;

FIG. 12B is schematic diagram of a top view of the setup of FIG. 12A;

FIGS. 13A-13D are graphs showing the transmission coefficient amplitude responses (S21) when injecting water beneath the sensor S01 (FIG. 13A), S03 (FIG. 13B), S05 (FIG. 13C), and S07 (FIG. 13D);

FIG. 14 is a schematic of a fully integrated tag showing the sensors and the send/receive antennas;

FIGS. 15A and 15B are graphs showing the measured transmission coefficients (S21 in dB) when injecting water beneath the 7th and 6th sensors, respectively;

FIG. 16 is a 3D model showing the distributed sensor array for application on the bottom of an oil tank;

FIG. 17A shows a top view of a sensor array of 11-elements;

FIG. 17B shows a side view of the sensor array of FIG. 17A applied on the different system layers;

FIG. 18 is a graph showing the frequency response when cascading sensors along the array which all resonate at the same frequency;

FIG. 19 is a graph showing the measured S21 (in dB) when moist samples are inserted under different sensors;

FIG. 20 is a graph showing the measured S21 (in dB) when gaps (representing coating delamination) are inserted under different sensors

FIG. 21A shows an experimental setup for liftoff and water ingress measurement between the coating and metal pipe using chipless RFID tag; and

FIG. 21B shows the RFID tag dimensions (in cm) for the experimental setup of FIG. 21A.

### DETAILED DESCRIPTION OF THE INVENTION

The present invention has utility as a method and apparatus for detecting breaches in a coating layer of a pipe. The inventive method and apparatus also have utility for prediction of water ingress and/or coating degradation prior to failure in pipeline systems.

Embodiments of the present invention provide a chipless or battery-free radio frequency identification (RFID)-based sensor for pipeline integrity monitoring in a real-time manner. The sensor monitors coating delamination from the pipeline, which is the initial step in external corrosion of a metal pipe. The sensor has a readout coil and an inductor and capacitor (LC) resonator on a passive LC tag with an interdigitated capacitor. The resonant frequency of the sensor demonstrates a strong relation to the gap between the coating and the metal pipe. The LC tag is built on a flexible substrate for wrapping around the pipe and to represent the pipe coating. The sensor is conformal, battery-free (independent of a battery for powering the sensor reader), and low cost which makes it suitable for pipeline monitoring in harsh environments. According to embodiments, the resonator is tuned to 105 MHz with a Q factor of ˜115. The sensor demonstrates a maximum resonant frequency change of 11.7%, when 2 Standard Cubic Centimeter per Minute (SCCM) of air lifts the coating and 7.46% when 4 mL of water is present between the coating and the pipe. This sensor has advantages of inexpensiveness, simplicity, and long lifetime.

In certain inventive embodiments, logs of a series of inventive sensor systems positioned along a pipeline are collected and analyzed for changes as a function of time. Such interrogation logs are readily normalized for localized environmental variations by conventional methods that illustratively include collection of at least two data sets in rapid succession so changes associated with actual degradation of the pipeline can be discounted as a contributor to the collected data sets and therefore serves as a baseline. The resulting logs are then analyzed to preemptively to detect pipeline degradation before a failure occurs.

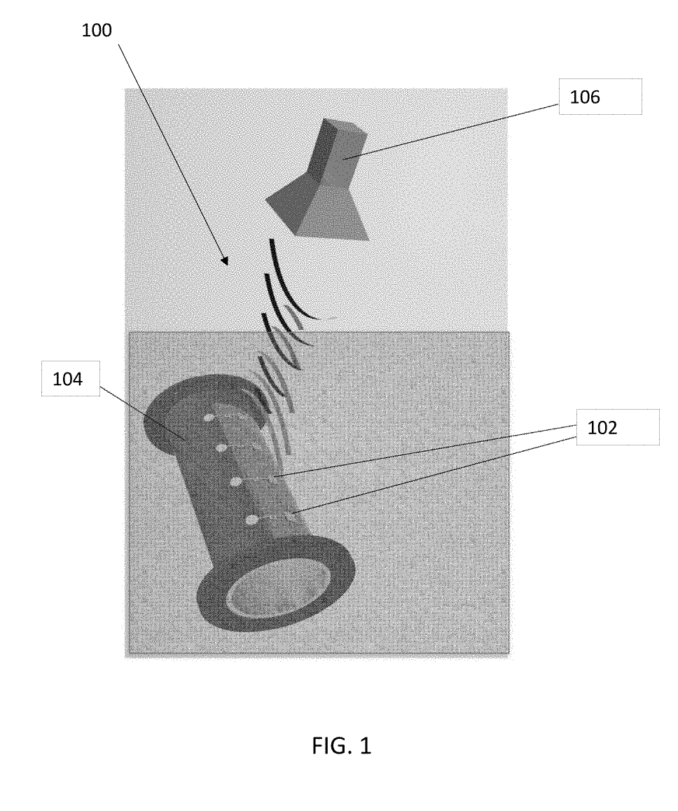

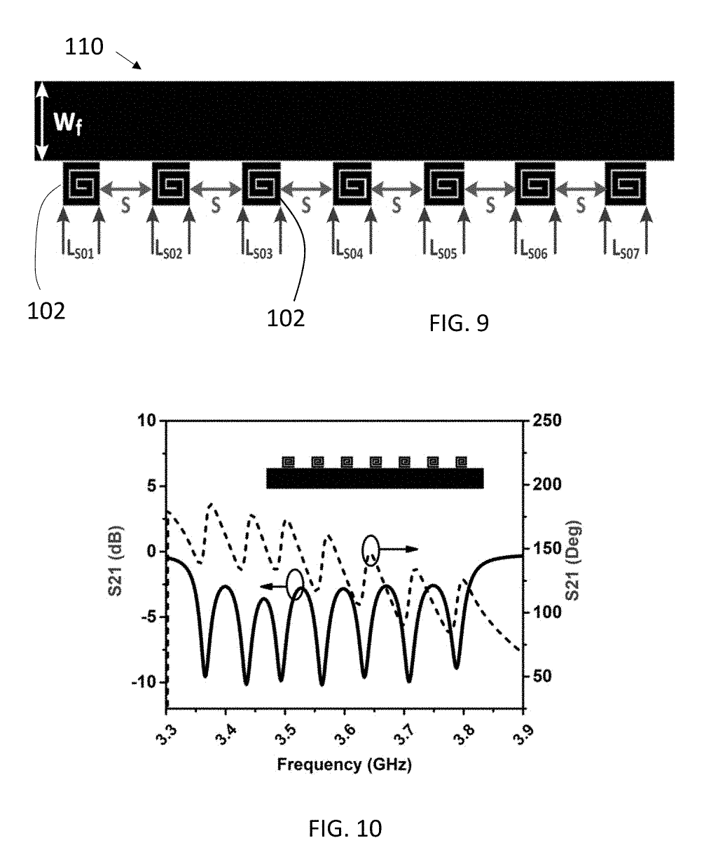

FIG. 1 shows an embodiment of the inventive system 100 according to the present invention. The system 100 includes at least one reporting sensor 102. According to embodiments, the reporting sensor 102 is a chipless RFID sensor with inductor and interdigitated capacitor (LC) tag. The sensor(s) 102 are applied to a pipe 104. According to embodiments, the sensor(s) 102 are adhered or stamped onto the pipe 104. Breaching of the polymer coating results in distance variation between the coating and metal pipe and consequently affects the interdigitated capacitor on the tag. The capacitor variation is wirelessly transferred to a reader coil 106 and its effect is reflected in return loss parameter (S₁₁). The inventive sensor system is capable of detecting air and/or water penetration underneath the coating, which are indicative of pipeline degradation. According to embodiments, a method is provided for using the inventive sensor system 100 and a single readout coil to detect the breaching of piping coating under an array 110 (FIG. 9) of sandwiched sensors 102 on the pipe, individually and sequentially.

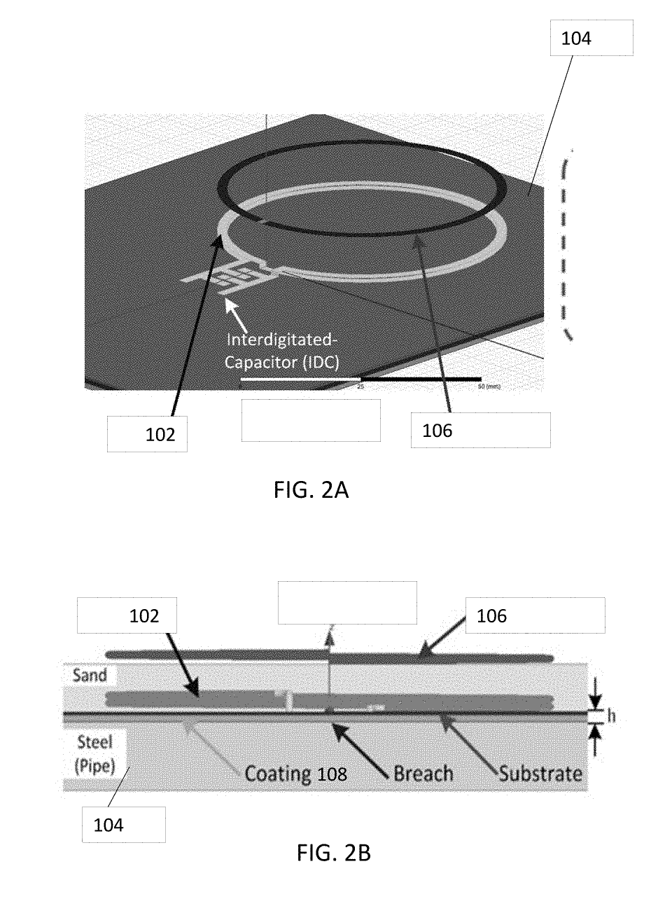

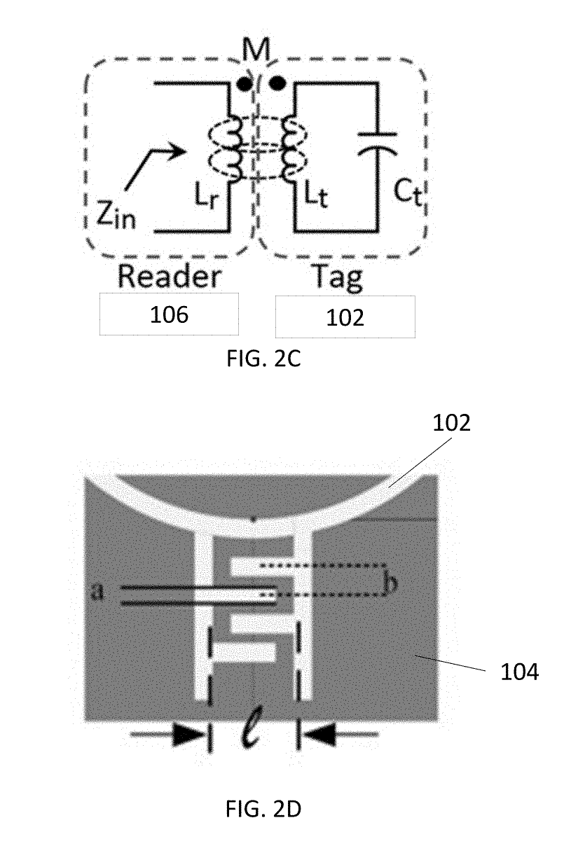

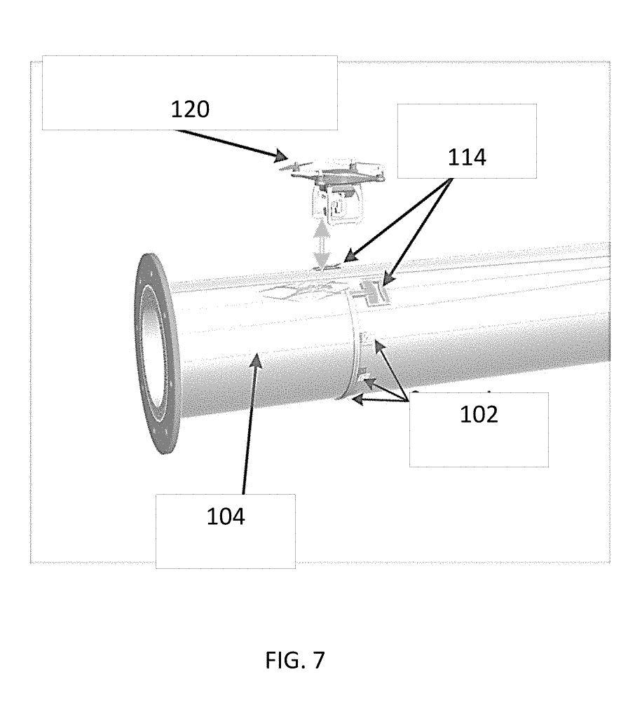

FIGS. 2A and 2B show a chipless RFID sensor 102 with LC tag along with its lumped circuit model shown in FIG. 2C. The sensor 102 has a reader coil 106, which is connected to readout circuitry, a coil, and an interdigitated capacitor (IDC) on the tag side. The IDC design has four fingers with its dimensions shown in FIG. 2D. The connection between the readout circuitry and sensing tag 102 is established by a magnetic link in between the tag-coil and reader-coil as shown in FIG. 2C. According to embodiments, the tag 102 is implemented on a flexible substrate, for example Ultralam 3850 from Rogers Corporation with the dielectric constant of 2.9 and dielectric thickness of 100 μm. The sensor patterns can be printed on the coatings. According to embodiments, the reader is attached to or mounted on an autonomous vehicle, such as a drone 120, best shown in FIG. 7. It will also be understood that other autonomous vehicles are also envisioned such as a plane, a helicopter, or submersible vehicles.

In some embodiments, the system may include a single layer or a multilayer metallic pattern on the pipe coating, comprising a single resonant structure or an array 110 of resonant structures at radio frequency and microwave range, where the resonant behavior (frequency, quality factor and amplitude) and coupling of the elements is used as a sensing identification parameter. Additionally, a single layer or multilayer metallic pattern on the pipe coating may comprise a single non-resonant structure or an array of non-resonant structures that interact with the microwave field and impact the amplitude and phase of the signal, the impact and the change in the signal then is evaluated as a finger print of the parameters to be sensed.

According to further aspects of the present invention, the sensors 102 may be stamped or printed on the coating layer 108 of the pipe 104. The sensor elements and the antennas can be printed using a conductive material or conductive ink. The sensor 102 may also include an antenna, or any coupled structure to wirelessly communicate the sensed information to the reader 106. The system is capable of off-sight readings through an array 110 of resonators (sensors) 102 along the pipeline circumference and sending information to the off-sight reader 106 through Tx/Rx antennas. Off-sight readings can be used to read all around the pipe.

In some embodiments, the sensors 102 may be intercoupled. Such inter-element coupling may be used to detect the location of a defect or a breach and have or provide a spatial resolution. Reading and monitoring the resonant behavior of the RFID sensor 102 using the system 100 provided herein allows for proactive prediction of a cause (coating condition, water ingress, sand penetration, etc.) of a breach or corrosion, rather than sensing corrosion or a breach directly. Reading and monitoring the resonant behavior of the RFID sensor 102 using the system 100 further provides the ability to proactively predict stress on the pipe 104 by monitoring coating 108 quality and thinning.

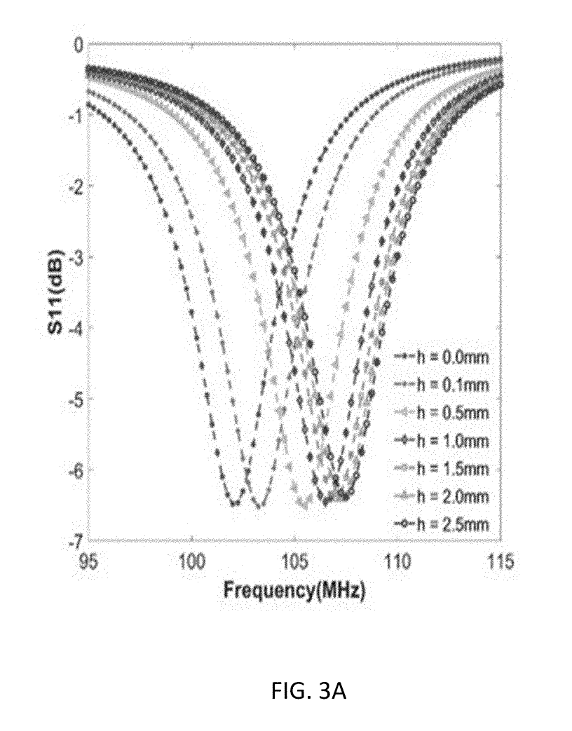

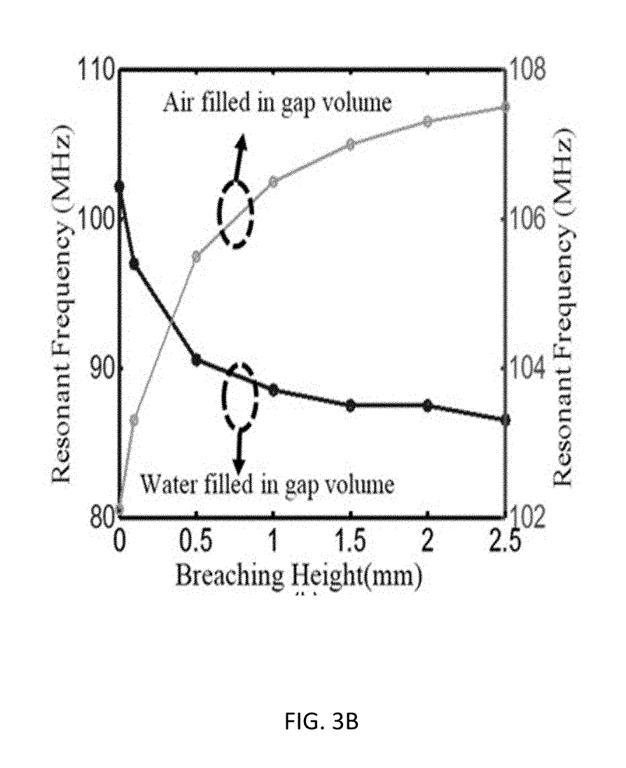

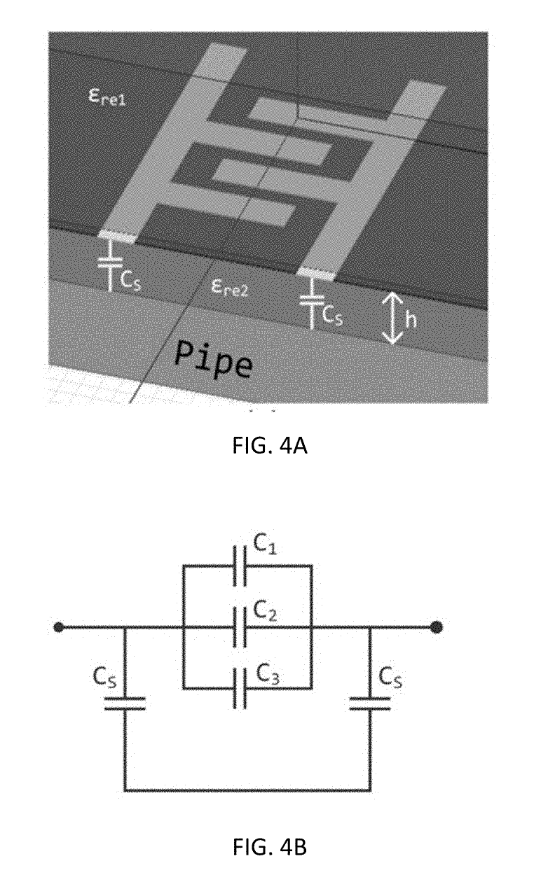

To simulate the coating 108 lift-off or water ingress process, the distance between the coating 108 and incorporated sensor 102 with the steel pipe 104 is changed and the gap volume is filled with air (εᵣ≅1) or water (εᵣ≅80) material. As shown in the simulation results of FIG. 3B, coating lift-off, which is caused by air demonstrates an up-shift in resonant frequency; where for water ingress, the resonant frequency has a down-shift variation as a response to the process. The direction on resonant frequency change can be used as an indicator for determining the cause of damage on the pipe coating. This can be described by capacitor change per unit length on the sensor tag (Cₜ) and its effect on the input effective impedance seen by the readout circuit at the receiver side (Zᵢₙ).

As shown in FIG. 3A, the total capacitance of the IDC depends on fringing capacitance through εᵣₑ₁(C₁), fringing capacitance through εᵣₑ₂(C₂), the IDC finger space parallel plate capacitance (C₃), the coupling capacitance through the pipe surface (Cₛ). The overall interdigitated capacitance excluding the impact of the pipe is Cₜ=C₁+C₂+C₃ which can be calculated as follows (1), (2):

$$\begin{matrix}{C}_{t} = ( {ɛ}_{r} + {ɛ}_{s} ) {κɛ}_{0} , & ( 1 ) \\ κ = \frac{l ( {N}_{c} - 1 ) {K [ 1 - {( \frac{a}{b} )}^{2} ]}^{\frac{1}{2}}}{2 K [ \frac{a}{b} ]} , & ( 2 )\end{matrix}$$

where Cₜ is the tag interdigitated capacitor, ε₀ is the free space permittivity (ε₀=8.854×1012 F/m), εᵣ is the environment permittivity, εₛ is the substrate permittivity, a, b and l are dimensions defined in FIG. 2D, N_{C} is the number of capacitor electrodes, and K is the elliptic integral of the first kind.

The impact of the pipe is considered through Cₛ which is mainly calculated based on the two series parallel plate capacitances between the IDC and the pipe surface, calculated as follows:

$${C}_{s} \text{∼} \frac{{ɛ}_{re 2} A}{h} \qquad ( 3 )$$

where h is the distance between the IDC and the pipe, εᵣₑ₂ is the effective permittivity including the substrate, the coating, and the air/water breach, and A is the common area between the IDC and the pipe. Breaching of the coating affects the substrate's permittivity (εₛ) in between the sensor and the coating impacts Cₛ and Cₜ through variation in h and εᵣₑ₂ and results in variation on the overall capacitor of the LC tag.

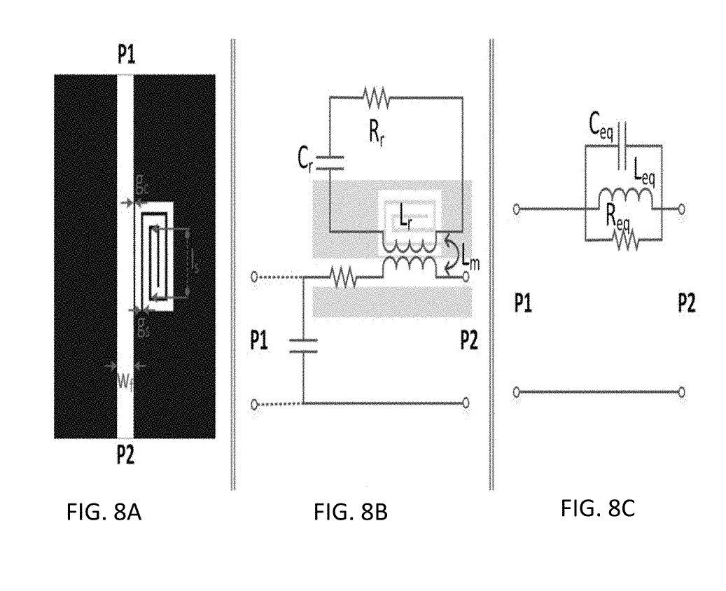

According to embodiments, the sensor array 110 elements may be of non-identical shape along the array each one creates its own resonance frequency. Using such embodiment, one can tell the defect location which will be related to a change in a unique resonance. The sensor element 102 can be of many shapes, for example, spiral ring resonator as shown in FIG. 8A. It shows a one embodiment of the sensor elements in FIG. 8A and its circuit model representations in FIGS. 8B and 8C. FIG. 9 shows an embodiment of a plurality of sensor elements 102 in an array 110 for non-identical representation. In FIG. 9, the sensor elements 102 in the array 110 are coupled to a transmission line electromagnetically and the distance between each two consecutive sensors 102 is S.

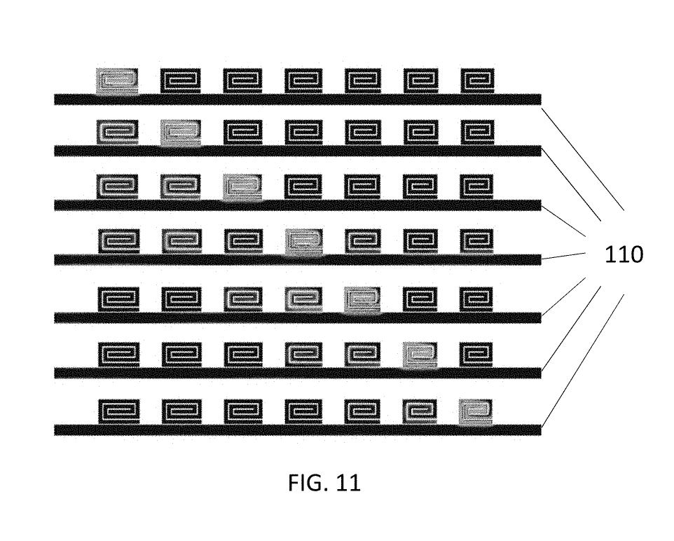

The representation in FIG. 9 for the sensor elements 102 in an array 110 producing a spatial signature (frequency signature) where each notch (stopband) is corresponding to a specific element in the array as shown in FIG. 10. At each resonance, the EM signal is coupled electromagnetically to the specific element as shown in FIG. 11.

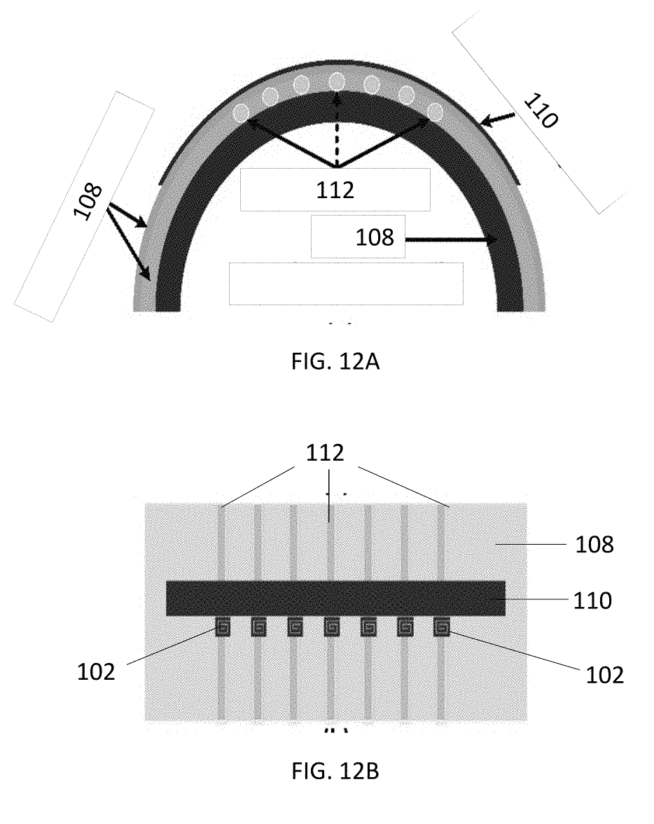

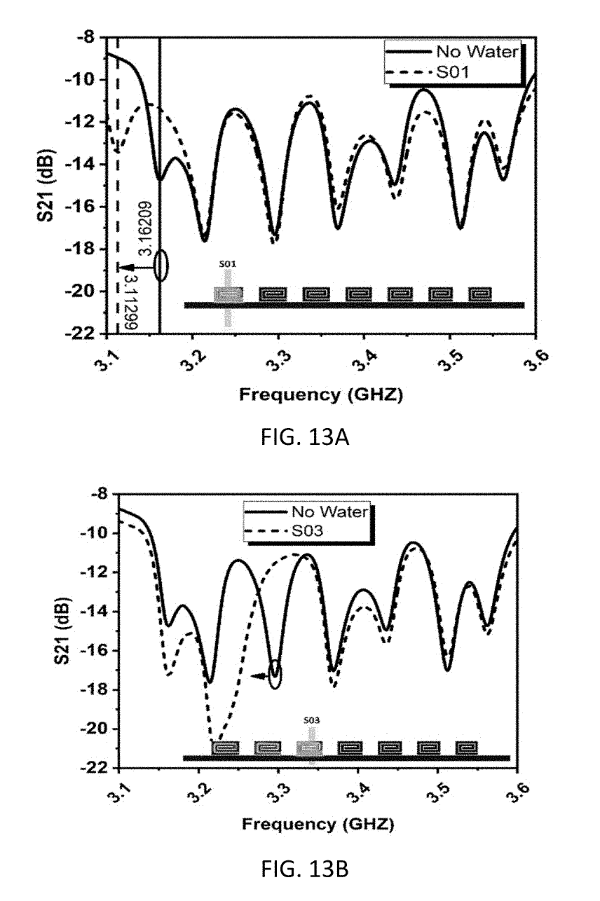

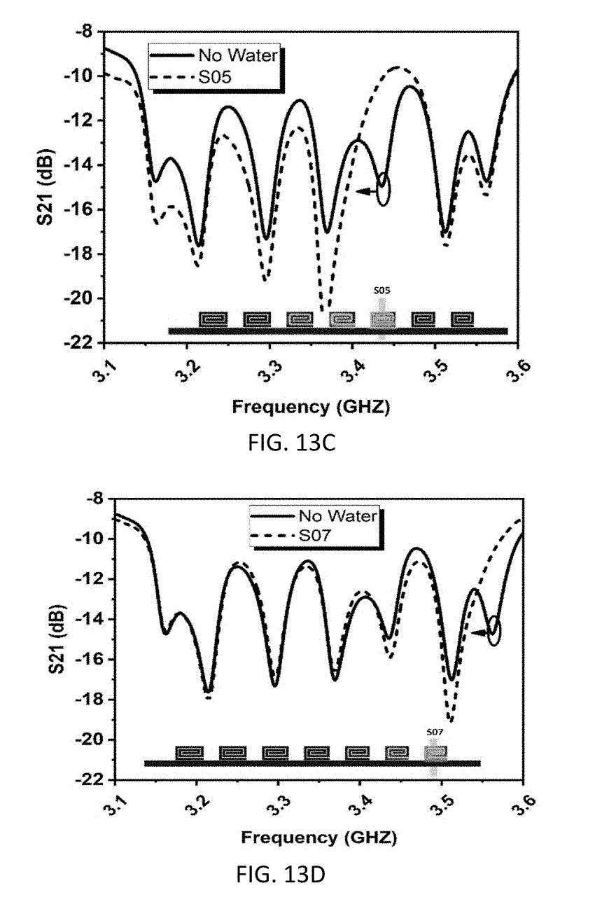

FIGS. 12A and 12B show an array 110 of sensors 102 printed and wrapped around a pipe 104 perimeter. When each element's 102 environment is perturbated, its unique resonance frequency is shifted accordingly. For example, if water ingresses under the coating 108 (experimentally shown in FIGS. 12A and 12B as the polymer tubes 112 for supplying water), the specific sensor's 102 resonance will shift down accordingly as shown in FIGS. 13A-13D for sensor elements 1, 3, 5, and 7 as an example. The results show the capability of the system and method to provide information regarding water ingress below the coating 108 as well as locating breached area by knowing each sensor's resonance and it predetermined location.

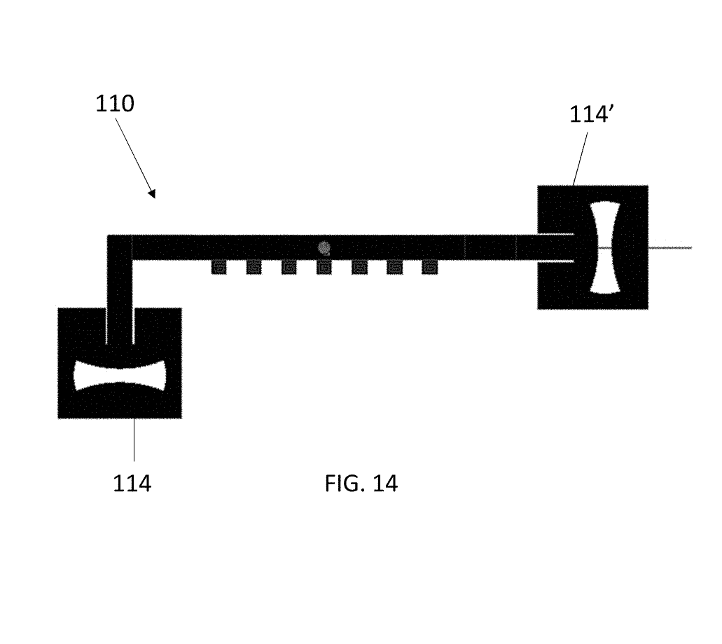

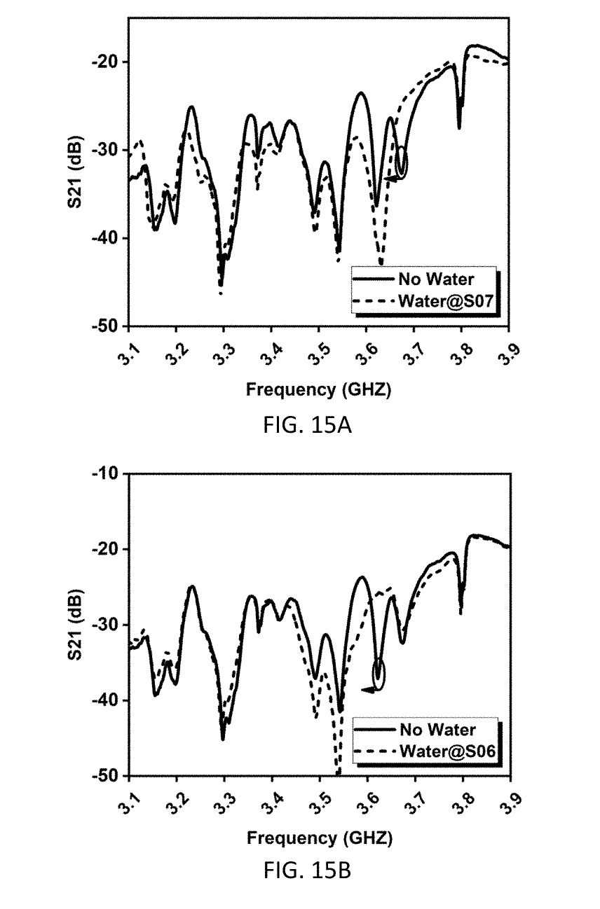

According to embodiments, the sensor array 110 includes a Tx/Rx antenna 114. The Tx/Rx antenna 114 utilizes the steel pipe 104 structure as a ground plane (GND) as well as the sensor layer shown in FIGS. 12A and 12B. The antennas 114 have a planar profile to be printed or stamped on the coating layer. FIG. 14 shows the sensor array 110 with the Tx/Rx antennas 114 printed on a flexible material and can be wrapped around a pipe curvature. One antenna 114 will receive a signal from an interrogator (reader) and send it through the transmission line which will be MODULATED by the coupled resonators at each specific frequency accordingly. Then, the MODULATED signal will be sent out through the other antenna 114′ to be read wirelessly using the reader unit 106. According to embodiments, the Tx/Rx antennas 114, 114′ (Tag antennas) are planar, linearly polarized antennas such as microstrip slot antennas. The results shown in FIGS. 15A and 15B prove the concept of detecting the water ingress below the sensors 102.

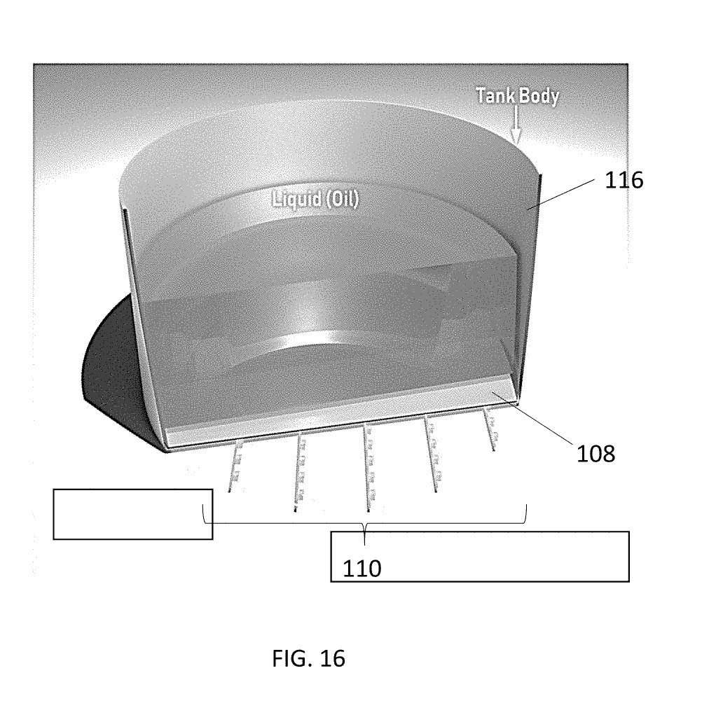

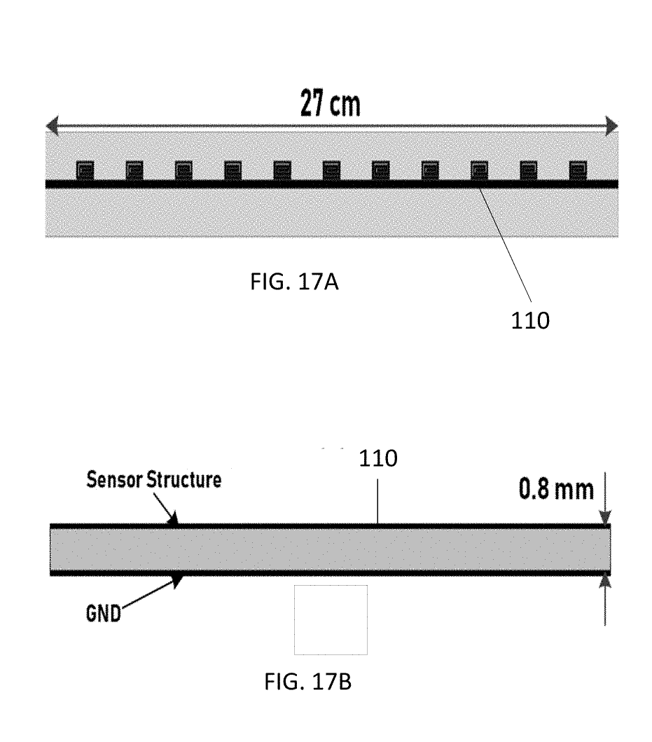

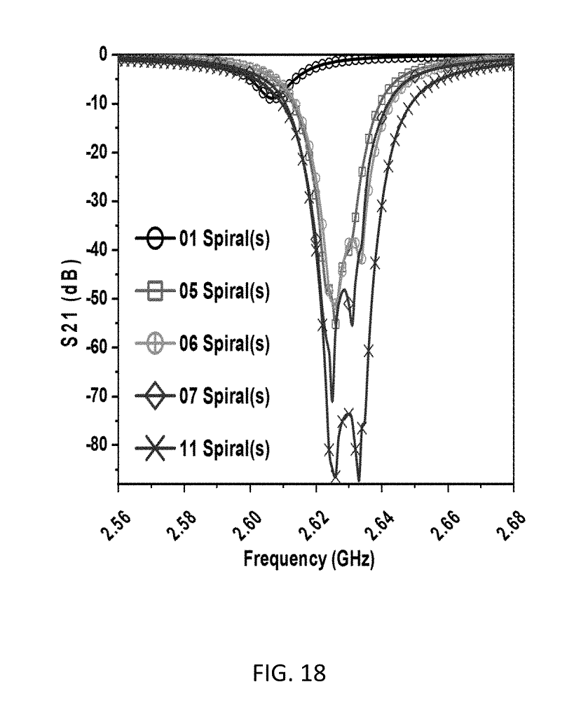

According to embodiments, the sensor array elements 102 may be of identical shape along the array 110 and all produce the same resonant frequency. Each sensor 102 creates its own resonance frequency. According to embodiments, an inventive sensor array 110 is placed at the bottom of a tank 116 sandwiched within the coating a coating 108 as shown in FIG. 16. The sensor array elements 110 fabricated on a substrate is shown in FIGS. 17A and 17B. FIG. 18 shows the frequency response when cascading sensors along the array which all resonate at the same frequency.

When the environment of any of the array elements is affected by any defects, for example coating defects or degradation, water ingress, or delamination, a new resonance will be created based on the cumulative dielectric permittivity (εᵣ′) created around the sensor's area of coverage. For example, if increases (e.g. due to water ingress), the new generated frequency will show up in a lower range than the fundamental array resonance. On the contrary, if εᵣ′ decreases (e.g. coating delamination with an air gap is created), the new frequency appears in a higher range than the array's fundamental one.

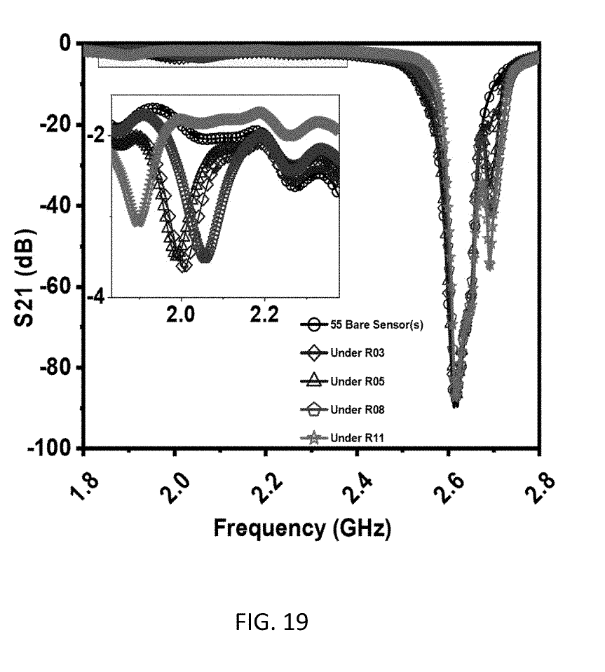

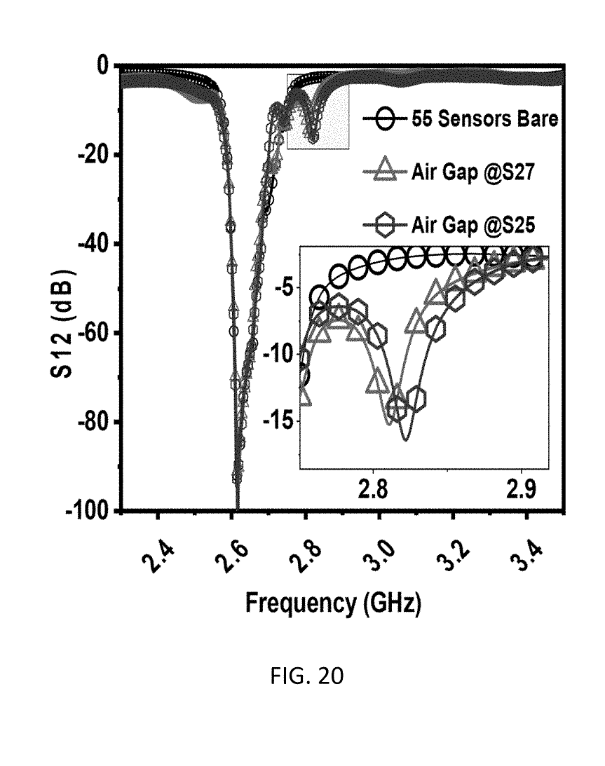

According to embodiments, the inventive sensor system 100 includes anywhere from one to thousands of sensor arrays 110. Each sensor array 110 includes anywhere from one to hundreds of sensors 102. A length of a sensor array 110 depends on how many sensors 102 make up the array 110 and the distance between each of the sensors. For example, an embodiment of a 55-sensor array 110 sensor array has a length of 120 cm which consists of 5 blocks of 11-element array. FIG. 19 shows the created resonances when inserting a wet paper under each sensor's layer, demonstrating that the sensor array can recognize such coating defects of water ingress. In addition, a coating delamination represented by creating air gap under the sensor was detected and created a higher frequency resonance as expected, shown in FIG. 20.

### Examples

The present invention is further described with respect to the following non-limiting examples. These examples are intended to illustrate specific formulations according to the present invention and should not be construed as a limitation as to the scope of the present invention.

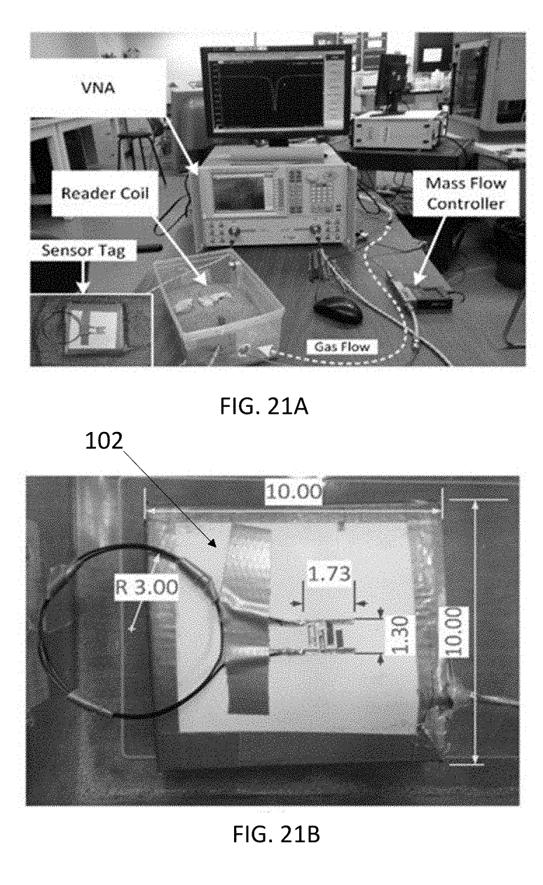

An experimental setup is presented in FIGS. 21A and 21B, where the sensor tag 102 is implemented on a piece of metal pipe with appropriate coating, such as a fusion bonded epoxy, polyethylene, or Epoxy-100. A PTFE polymer tube is used to bring air and water to create the lift-off and water ingress. A mass flow controller (MFC) controls the air flow rate precisely. The air flow increases the trapped air volume between the coating and the pipe's outer wall and consequently, affects the bulging volume of the coating on the pipe. This also impacts the gap between the sensor and the pipe and reflects in electrical responses of the sensor.

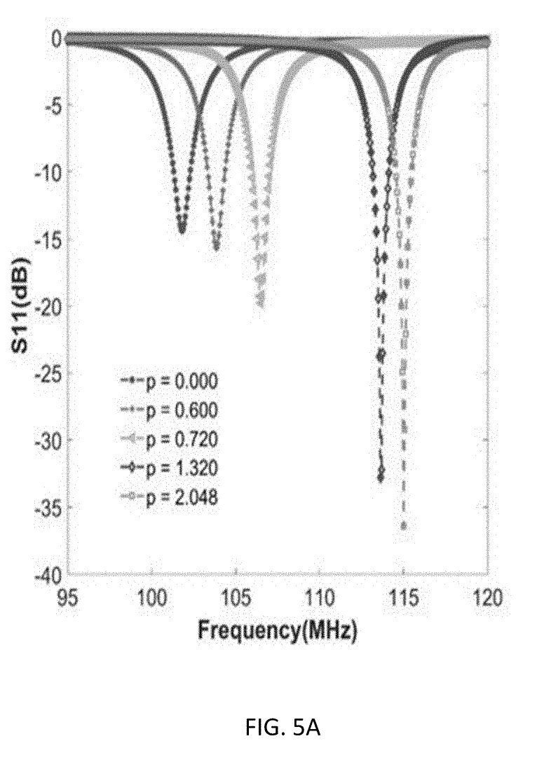

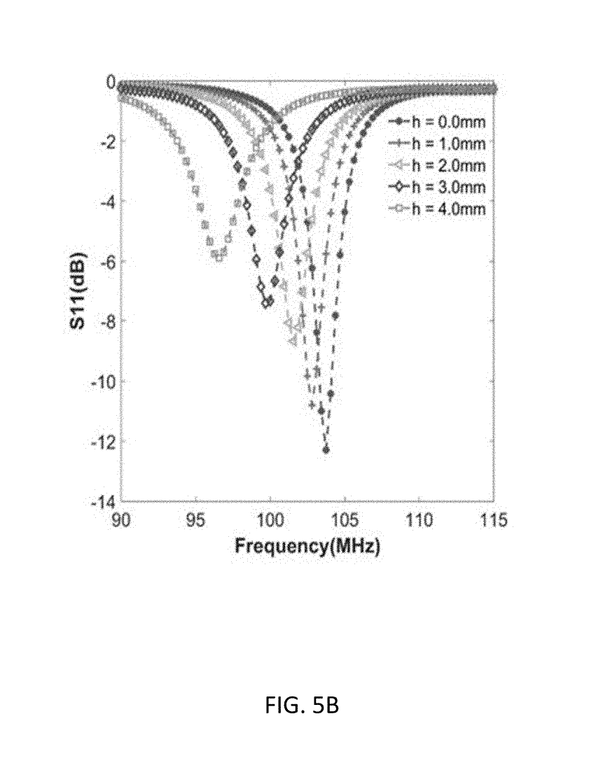

The implemented tag and metal piece (FIG. 5B) is located under a sand pile with permittivity of (˜2.5) and the thickness of the sand between the tag and the reader coil is (˜1.0 cm). A Vector Network Analyzer from Agilent (E8361C) measures the return loss parameter (S11) from the reader coil. The initial sensor configuration without injecting air or water demonstrates a resonant frequency of 105 (±2) MHz. The sensor is buried under a thick layer of protective coating and is very close to the pipe surface which makes the moisture variation in the soil around the pipe negligible.

FIG. 5A presents the resonant profile variation for different rates of air flow, which causes gap volume variation in between the coating and the metal pipe. The confined air in the gap volume reduces the effective tag capacitor, and increases the resonant frequency consequently. In contrast, having water ingress in between the coating and the metal pipe increases the effective permittivity in the capacitor environment and leads to down-shift in resonant frequency as shown in FIG. 5B. Knowing the water ingresses volume and the pipe section area, the volumetric change may be translated into mm. The direction of the variant resonant frequency can be used as an indicator to distinguish between the two causes of failure in between the coating and the pipe.

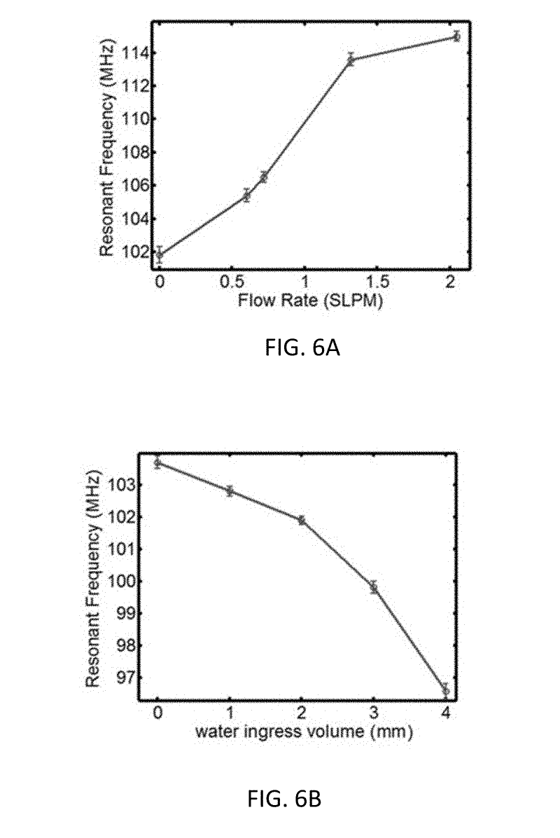

To assure accuracy of the results, S11 parameters are measured two minutes after applying the air/water purging. In addition, every measurement is performed five times and the results are presented with error-bar in FIGS. 6A and 6B. As shown in FIGS. 6A and 6B, the slope of the resonant frequency variation is positive when the coating to pipe gap volume is filled with air; where it is negative, when water filled gap creates the defect. The results clearly demonstrate that the sensor distinguishes the two different causes of coating failure capable of predicting corrosion occurrence.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient roadmap for implementing the exemplary embodiment or exemplary embodiments. It should be understood that various changes may be made in the function and arrangement of elements without departing from the scope as set forth in the appended claims and the legal equivalents thereof.

1. A system for detecting compromise of a coating on a vessel and its causes, the system comprising:
a resonant passive radiofrequency design-based sensor at least partially positioned on a coating layer of the vessel; and
a reader for reading a resonant behavior of the sensor, wherein the reader reads the sensor wirelessly.

2. The system of claim 1 wherein the resonant behavior of the sensor includes a resonant frequency, a quality factor, and an amplitude readings.

3.-4. (canceled)

5. The system of claim 1 wherein a variation in the resonant behavior of the sensor is indicative of a breach in the coating layer or stress, strain, cracks, and corrosion on the vessel structure.

6. The system of claim 1 wherein the sensor includes an antenna configured to wirelessly communicate with the reader.

7.-11. (canceled)

12. The system of claim 1 wherein the reader reads the sensor by a magnetic or electric link between a reader and the sensor.

13. The system of claim 1 wherein the sensor is stamped or printed on the coating layer.

14. The system of claim 1 further comprising a plurality of passive sensors, wherein the plurality of passive sensors form a single layer or multilayer metallic pattern of resonant structures on the coating layer, the resonant structures having a radio frequency and a microwave range, or wherein the plurality of passive sensors form a single layer or multilayer metallic pattern of non-resonant structures that interact with a microwave range and impact a reflected signal from the reader.

15.-18. (canceled)

19. The system of claim 14 wherein the plurality of passive sensors are positioned around a circumference of the vessel, along a linear extent of the vessel, or a combination thereof.

20. (canceled)

21. The system of claim 1 wherein the reader is an RFID reader, a network analyzer, or a spectrum analyzer.

22.-25. (canceled)

26. The system of claim 1 wherein the vessel is metal and grounds the sensor.

27. (canceled)

28. The system of claim 26 further comprising at least one planar antennas that use the metal vessel as a ground plane and wherein the metal vessel is part of each antenna structure.

29.-31. (canceled)

32. A method for monitoring a condition of a coating layer of a vessel, the method comprising:
positioning an array of a plurality of resonant passive radiofrequency design-based sensors on the coating layer of the vessel;
reading a resonant frequency of each sensor of the plurality of resonant passive radiofrequency design-based sensors using a reader; and
monitoring the resonant frequency of the plurality of sensors for a variation in the resonant frequency of at least one sensor of the plurality of sensors, wherein the variation in the resonant frequency of the at least one sensor indicates a change in the condition of the coating layer.

33. The method of claim 32 wherein reading the resonant frequency of each sensor includes passing the reader by the plurality of sensors.

34. The method of claim 33 wherein passing the reader by the plurality of sensors includes flying a drone carrying the reader near the vessel.

35. The method of claim 32 further comprising repeatedly reading the resonant frequency of each sensor of the plurality of resonant passive radiofrequency design-based sensors as a function of time to generate temporally displaced data sets and comparing the temporally displaced data sets for changes within the data sets indicative of changes in the condition of the coating layer.

36. (canceled)

37. The method of claim 32 wherein a decrease in the resonant frequency of the at least one sensor is indicative of a water penetration breach of the coating layer, and wherein an increase in the resonant frequency of the at least one sensor is indicative of an air penetration breach of the coating layer.

38.-43. (canceled)

44. The method of claim 32 wherein each of the plurality of sensors is excited through at least one of wireless coupling, transmission lines, or the transmission lines connected to antennas.

45. The system of claim 6 wherein the antenna is planar and conformal to the vessel surface with linear polarization for receiving an interrogator signal and for sending a modulated signal.

46.-47. (canceled)

48. The method of claim 32 wherein reading the resonant frequency of each sensor of the plurality of sensors is accomplished from one end or an intermediate hub without the need for direct line of sight to each of the sensors.

49. The system of claim 14 wherein each of the plurality of sensors has a unique resonant frequency signature.

50.-82. (canceled)
